(19) United States
(12) Patent Application Publication
(10) Pub. No.: US 2007/0241242 A1
(43) Pub. Date: Oct. 18, 2007

(54) Break-apart conduit bracket sheet

(76) Inventor: John Gordon Kopp, San Clemente, CA (US)

Correspondence Address: PATENT LAW & VENTURE GROUP, 2424 S.E. BRISTOL, SUITE 300, NEWPORT BEACH, CA, 92660, US

(21) Appl. No.: 11/404,139

(22) Filed: Apr. 14, 2006

(51) Int. Cl. F16L 3/08; F23J 13/02

(52) U.S. Cl. 248/74.5; 126/307 R

(57) ABSTRACT

A plurality of brackets formed as straps from a single piece of sheet material are useful for supporting pipes, vents, flues and similar articles. The straps are mutually joined in side-by-side positions by frangible tabs so that they are easily broken apart, one from the other, by manual bending of the frangible tabs. Each of the straps provides, at each one of its opposing ends, in spaced apart sequence, starting at the terminal ends and moving medially along the straps, features formed in the sheet material, including: a mounting hole for receiving a fastener, a slot for receiving a tab, a fastener access hole, and a tab.

### BACKGROUND OF THE INVENTION

1. Field of the Present Disclosure

This disclosure relates generally to the support of pipes in general and exhaust flue pipes and vents in particular, and more specifically to an apparatus providing connected but easily broken apart sheet metal strips that are easily formed into a strap-like bracket facilitating the securement of such conduits.

2. Description of Related Art Including Information Disclosed Under 37 CFR 1.97 and 1.98

Reynoso, U.S., Des 257947 discloses a design for a bracket for mounting a heater vent pipe between joists and rafters. Williamson, U.S. Pat. No. 851,720 discloses a flue support consisting of two parallel spaced U-shaped metal straps having their extremities turned outwardly at right angles in a common plane, and a pair of independently formed parallel spaced cross-straps, disposed upon the web portions of the U-shaped straps and having their ends turned downwardly against the outer edges of the webs of the U-shaped straps, whereby longitudinal displacement of the cross-straps from the U-shaped straps is prevented. Grissom, U.S. Pat. No. 973,777 discloses a flue base, a pair of supports spaced from each other, each support being of substantially U-shape and having outwardly bent and down-turned hook like ends for engagement with adjacent joists, and a centrally perforated flat plate normally resting upon the cross connecting portions of the supports and having notches formed in opposite side edges receiving the vertical leg portions of the supports, whereby the plate will be held against displacement with respect to the latter without the use of fasteners. Anderson, U.S. Pat. No. 1,127,844 discloses a device comprising in combination a pair of U-shaped stirrups the legs of which are bent to hook formation at their terminals to adapt them to engage over spaced supports, the stirrups lying in space relation to each other, bars extending between the stirrups with their ends resting upon the stirrups, the stirrups and the bars together comprising an open, rectangular and continuous support and a sheet metal plate supported upon the bars and the stirrups and completely overlying the bars and the horizontal portions of the stirrups the plate serving as a base and a closure for the bottom of a brick flue, the bars and the stirrups underlying the line of the bricks of which the flue is made and the plate having an opening formed therein for the reception of a stove pipe. Legg, U.S. Pat. No. 1,342,918 discloses a flue with an open bottom having a pipe entering the open end thereof, of a flue pan arranged beneath the open bottom of the flue provided with a central aperture adapted to receive the pipe and a tubular member secured to the pan and extending upwardly into the flue surrounding the pipe, the tubular member being provided on the upper end thereof with a resilient flange engaging the pipe. Epstein, U.S. Pat. No. 2,648,326 discloses a spacer comprising: an elongated strip of deformable sheet metal formed with a longitudinal series of transverse extensions severed from the strip along their opposite sides and one end only, and bent outward from the strip along the other end which extensions are additionally bent adjacent the first end at a distance from the strip beyond the deformable limits of the strip-secured metal to provide footing portions collectively adapted to abut against the perimeter of a structure around which the strip may be wound so as to space the same apart therefrom, and means for fastening the wound strip to a supporting structure the strip of metal having longitudinally extending dimples stiffening the strip at the junctures of the respective extensions at their other ends, the stiffening dimples terminating at stations spaced from the junctures and defining unstiffened transverse bend lines for the strip between the extensions. Epstein, U.S. Pat. No. 2,648,511 discloses a hanger for a vertical vent pipe, the hanger comprising a vent pot means having a side and a bottom to receive the lower end of a support pipe, the hanger further comprising bracket means adapted to be supported on adjacent ceiling joists, hanger bar means supported on the bracket means, and the pot supported on the hanger bar means, the bracket means comprising a sheet metal body including a surface for securement against the side of one of the joists and having means offset from the plane of the surface, vertical slots formed in the offset means, the slots each having a downwardly tapered upper end portion and an enlarged lower end potion, the hanger bar means being horizontally supportable on the bracket means and having compressible end portions normally thicker than the slots at their narrowest tapered portions adapted to be snapped downwardly into individual slots, the bar means being longitudinally adjustable in the slots, the pot including a bottom and a side wall, the side wall of the pot having receiving means for the bar, the bar means being longitudinally slidable in the bar receiving means, the bar receiving means including portions normally frictionally gripping the bar. Goldstone, U.S. Pat. No. 2,965,342 discloses a vent pipe support including a frame adapted to be secured to spaced portions of a building, the frame including spaced members adapted to extend between the spaced building portions; a pipe supporting bucket having opposed, generally parallel end walls; brackets secured to the end walls and spaced therefrom in generally parallel relation thereto to provide guideways between the brackets and end walls to receive the spaced members with the bracket s and bucket supported on the space members, the sides of each guideway being defined by an end wall and a bracket secured to the end wall. Lane, U.S. Pat. No. 3,004,740 discloses a hanger for flue pipes comprising, a generally rectangular frame structure adapted to span a pair of spaced beams and to be secured thereto, a horizontally disposed clamping ring adapted to receive and hold a vertically disposed flue pipe against axial movements, and a plurality of circumferentially spaced centering brackets interposed between the clamping ring and the frame structure the brackets including vertical ears secured to the clamping ring, horizontal ears detachably secured to the frame structure, and angular body portions, the body portions defining radially inwardly projecting elements which are adapted to engage circumferentially space portions of a flue pipe in axially space relation to the clamping ring, whereby to hold the flue against angular movements with respect to the axis of the clamping ring. Stone, U.S. Pat. No. 3,602,468 discloses a support assembly for securing a prefabricated metal chimney or the like to a sloped roof and comprising a pair of bracket members adapted to be fixed to rafters on opposite sides of the chimney, each being adjustably connected to a plate member which is fixed to the chimney so that the chimney can be held vertically despite the degree of roof slope. Lane, U.S. Pat. No. 3,809,350 discloses a readily applicable device for use when the user is called upon to install a sheet material vent pipe. It comprises a simple adapter plate having a central opening for insertable and adjustable passage of a conventional type vent pipe, the apertured portion of the plate being encompassed by overhanging coordinating tabs. These tabs have upwardly flexed or canted inner ends which are slightly resilient and which embrace and yieldingly as well as retentively engage that portion of the vent pipe surrounded thereby.

The related art described above discloses several apparatus and methods known and in use for engaging and securing a vent flue or similar object. However, the prior art fails to disclose plural bracket straps fabricated from a single piece of sheet metal and although interconnect for commercial sale, may be easily broken apart for use in securing flue vents. The present disclosure distinguishes over the prior art providing heretofore unknown advantages as described in the following summary.

### BRIEF SUMMARY OF THE INVENTION

This disclosure teaches certain benefits in construction and use which give rise to the objectives described below.

The prior art described above as well as common practice in the construction trades provides methods and means for securing flue vents and pipes of all types. However there does not appear in the prior art to be a cost effective and convenient to use mounting bracket. The present invention provides such an apparatus and overcomes the jury-rigging approaches in common practice. Described herein is an exhaust flue mounting bracket made up as an elongate strap with certain features formed within it. Such straps are preferably formed and fabricated from a single piece of sheet material where they are joined by frangible tabs for easily breaking them apart. In one embodiment, several of these two-part assemblies are made from a single piece of sheet material and are packaged and sold as an assembly for use as needed. The fact that the parts are made at the same time by the same processes of forming and punching, and that they are connected as a single sheet enables low cost and simplified inventorying and convenient carrying to the job site, setting at the job site, i.e. standing it up vertically to take up almost no floor space room when in tight quarters and is therefore an example of a truly significant advance in the art. In particular, a plurality of brackets formed as straps from a single piece of sheet material are useful for supporting pipes, vents, flues and similar articles. The straps each provides, at each one of its opposing ends, in spaced apart sequence, starting at the terminal ends and moving medially along the straps, features formed in the sheet material, including: a mounting hole for receiving a fastener, a slot for receiving a tab, a fastener access hole, and a tab.

A primary objective inherent in the above described apparatus and method of use is to provide advantages not taught by the prior art.

Another objective is to provide a simple flue mounting bracket formed as a sheet material strip that is able to be wrapped about a pipe or flue and anchored to a supporting structure such as any wood frame or metal surface while holding the flue spaced apart from the mounting surface.

A further objective is to manufacture plural identical units from a single piece of sheet material by fabrication steps that finish all of the parts at the same time and without separating them so as to achieve cost effective production.

A still further objective is to provide a set of identical units easily broken away from each other in order to use each one as needed and to conveniently store remaining units for use at a later time.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING(S)

Illustrated in the accompanying drawing(s) is at least one of the best mode embodiments of the present invention In such drawing(s):

FIG. 1 is a perspective view of one unit of the presently described apparatus strips shown as used in one common application;

FIG. 2 is a sectional view taken along line 2-2 in FIG. 1.

FIG. 3 is a plan view of a plurality of the strips as formed from a single piece of sheet material and shown prior to a bending operation;

FIG. 4 is the plan view of FIG. 3 shown after the bending operation;

FIG. 5 is a perspective view of one of the strips shown prior to bending; and

FIG. 6 is the perspective view of the strip of FIG. 5 shown after the bending operation.

### DETAILED DESCRIPTION OF THE INVENTION

The above described drawing figures illustrate the described apparatus and its method of use in at least one of its preferred, best mode embodiment, which is further defined in detail in the following description. Those having ordinary skill in the art may be able to make alterations and modifications what is described herein without departing from its spirit and scope. Therefore, it should be understood that what is illustrated is set forth only for the purposes of example and that it should not be taken as a limitation in the scope of the present apparatus and method of use.

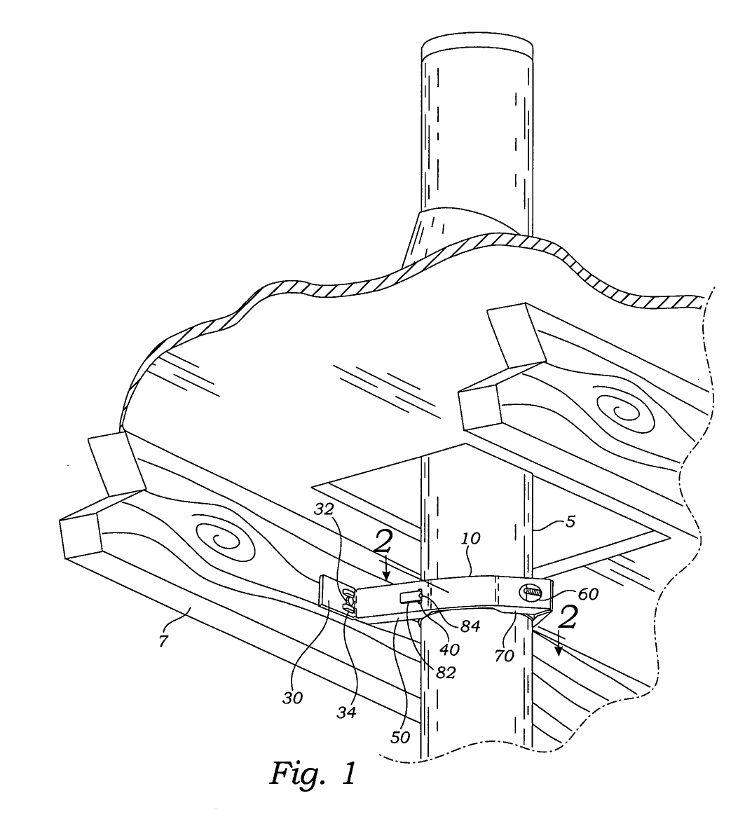

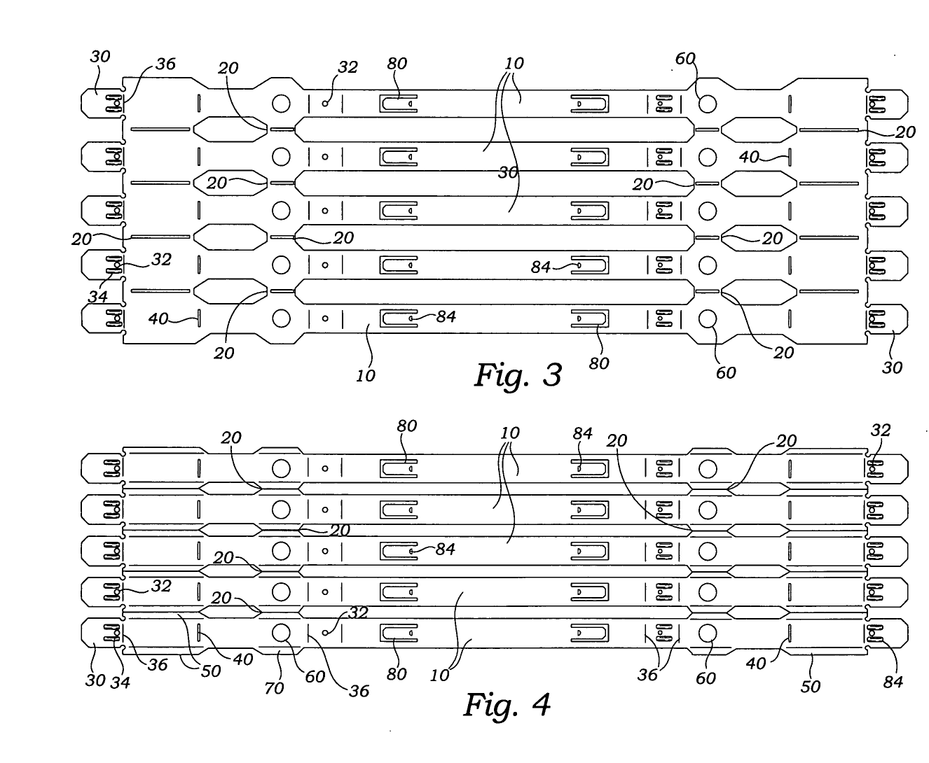

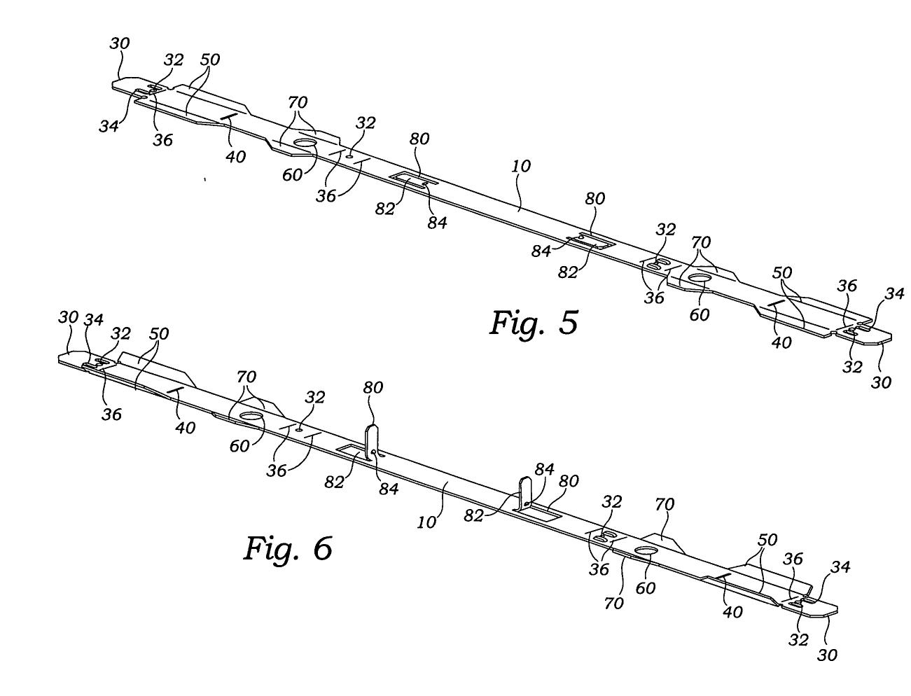

Described now in detail is the preferred embodiment of the present bracket apparatus and method of its use. Strap units 10 are able to secure a pipe, flue, conduit 5 to a support surface 7 as shown in FIG. 1. Although the strap units 10 may be fabricated individually, the preferred mode is to fabricate them in groups from a single piece of sheet material as shown in FIGS. 3 and 4. In FIG. 3 is shown a plan view of a single sheet of material, metal or plastic, which has been stamped and punched as a first step in preparing five of the strap units 10. In FIG. 4, the fabrication of FIG. 3 has been bent to form flanges as will be described further. FIGS. 5 and 6 shown a single strap unit as blanked and as bent respectively. When made as a group, the strap units 10 are arranged in side-by-side formation with only small portions of the sheet material connecting them. These connections are frangible tabs 20 so that the strap units 10 are easily broken apart, one from the other, by manual bending of the frangible tabs 20. In this way each one of the strap units 10 may be used in turn without disconnecting the others from the sheet. Each of the strap units 10 provides certain features which enable them to achieve the objectives described above.

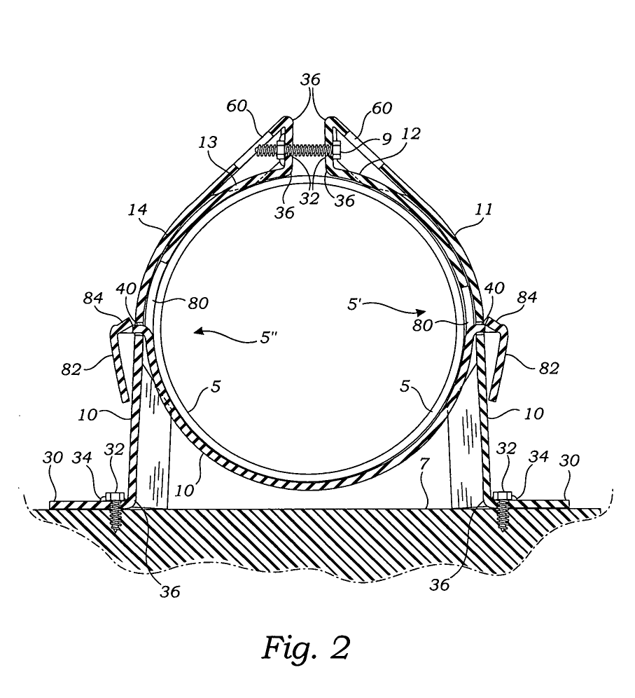

It is shown in FIGS. 5 and 6 that certain features are formed in the strap units 10 to enable them to meet the objectives defined above. Referring to FIG. 6, a finished strap unit 10, we see, starting at the left end moving medially to the right, the following features:
a) a tab portion 30 having a mounting hole 32 and, on each side of the hole 32, a dimple 34 as a turn restrictor for preventing a nut (not shown) from turning when the unit 10 is mounted on support surface 7 as shown in FIG. 2;
b) a laterally oriented bending crease 36 to assure a well positioned, tight bend of the tab portion 30, crease 36 being merely a score that weakens the material so that when manually urged, the tab portion 30 is more easily bent with the bend being at right angles to the long dimension of the unit 10;
c) a laterally oriented slot 40 of such size as to allow receipt of tab 82 defined in paragraph “i” below;
d) a first pair of opposing flanges 50 extensive between the bending crease 36 of paragraph “b” above and the slot 40, and which are bent at an angle to the strip unit 10 proper, such angle being generally between 45° and 80°;
e) a fastener access hole 60 of such size for receiving a fastener tool such as a socket driver;
f) a second pair of opposing flanges 70 positioned on either side of the access hole 60, and which are also bent at the same angle to the strip unit 10 as defined in paragraph “d”;
g) a further mounting hole 32 with clearance for a fastener such as a screw;
h) a pair of the laterally oriented bending creases 36 in spaced apart positions with the further mounting hole 32 between them; and
i) a cutout 80 defining a tab 82 extending toward the terminal tab portion 30, the tab 82 being flexible and long enough to be inserted into slot 40 and pulled through slot 40 until an upset 84 has been pulled through slot 40, the upset 84 preventing the tab 82 from withdrawing from slot 40. Alternatively, the tab 82, once inserted through slot 82 can be secured with a fastener such as a sheet metal screw, as is know to those of skill in the art.

It is noted that features “a” through “i” are repeated again on each strap unit 10, but starting at the right end and moving medially to the left. Preferably, one or the other of the further mounting holes 32 are provided with the turn restrictor 34, as shown.

In use, a strap unit 10 engages a pipe, flue or similar conduit 5 in such a way that the conduit 5 is held away from the surface 7 to which it is anchored. This is required by building codes when the conduit 5 carries hot fluids such as the exhaust fumes from furnaces, and the support surface 7 to which the conduit 5 is anchored is made of combustible material such as wood, which is most frequently the case. The preferred method of anchoring the conduit 5 to the support surface 7 as shown in FIG. 2 includes the following steps:
a) determine the location of the conduit 5 and the support surface 7 to which it will be anchored;
b) bend a tab portion 30 at one end of the strap unit 10 at roughly a right angle along crease 36, and anchor the tab portion 30 to the support surface 7 using a fastener as shown in FIG. 2;
c) extend the strap unit 10 around a first side 5′ of the conduit 5 to establish a first partial wrap 11 terminating just beyond the access hole 60 at crease 36;
d) bend the strap unit 10 at adjacent creases 36 so as to place the mounting hole 32 between the creases 36 in the position shown in FIG. 2;
e) extend the strap unit 10 further around the first side 10′ of the conduit 5 to establish a second partial wrap 12 that is positioned between the first partial wrap 11 and the conduit 5, and insert tab 82 on the second partial wrap 12 into slot 40 in the first partial wrap 11, pulling the tab 82 through slot 40 until upset 84 secures tab 82 in slot 40;
f) extend the strap unit 10 further around a second side 5″ of the conduit 5 to establish a third partial wrap 13 terminating just beyond a second access hole 60 in the strap unit 10 and assuring that the second access hole 60 is positioned opposite the first access hole 60 as shown in FIG. 2;
g) bend the strap unit 10 at further adjacent creases 36 so as to place the second mounting hole 32 between the creases 36 in the position shown in FIG. 2 opposite the first mounting hole 32;
h) fasteners 9 are now fastened through the mounting holes 32 to secure the third partial wrap 13 to the first and second partial wraps 11 and 12; but fasteners 9 are not tightened at this point;
i) extend the strap unit 10 further around the second side 5″ of the conduit 5 to establish a fourth partial wrap 14 that is positioned over the third partial wrap 13, and insert tab 82 on the third partial wrap 13 into slot 40 in the fourth partial wrap 14, pulling the tab 82 through slot 40 until upset 84 secures tab 82 in slot 40;
j) bend a tab portion 30 at the other end of the strap unit 10 along crease 36 at roughly a right angle to the strap unit 10 proper, and anchor the tab portion 30 to the support surface 7 using a fastener as shown in FIG. 2; and
k) tighten fasteners 9 so as to draw the first and second partial wraps 11, 12 toward the third and fourth partial wraps 13, 14 and to tighten the strap unit 10 around the conduit 5.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. A bracket apparatus for supporting pipes, vents, flues and similar articles, the apparatus comprising: a plurality of strap units formed in a single piece of sheet material, wherein the strap units are mutually joined in side-by-side positions by frangible tabs, the strap units being easily broken apart, one from the other, by manual bending of the frangible tabs;
each of the strap units providing, at each one of two opposing ends thereof, in spaced apart sequence, starting at the terminal ends and moving medially along the strap units, features formed in the sheet material, including:
a) a mounting hole for receiving a fastener;
b) a slot for receiving a tab;
c) a fastener access hole; and
e) a tab.

2. The apparatus of claim 1, wherein the sheet material features further include a fastener turn restrictor.

3. The apparatus of claim 1, wherein the sheet material features further include at least one bend crease.

4. The apparatus of claim 1, further comprising, near each of the opposing ends, a first pair of flanges in laterally opposing positions and formed at an angle relative to the strap unit.

5. The apparatus of claim 1, further comprising, adjacent to each of the fastener access holes, a second pair of flanges in laterally opposing positions and formed at an angle relative to the strap unit.

6. A bracket apparatus for supporting a pipe, vent, flue and similar articles, the apparatus comprising: a strap unit formed from sheet material;
the strap unit providing, at each one of two opposing ends thereof, in spaced apart sequence, starting at the terminal ends and moving medially along the strap unit, features formed in the sheet material, including:
a) a mounting hole for receiving a fastener;
b) a slot for receiving a tab;
c) a fastener access hole; and
e) a tab.

7. The apparatus of claim 6, wherein the sheet material features further include a fastener turn restrictor.

8. The apparatus of claim 6, wherein the sheet material features further include at least one bend crease.

9. The apparatus of claim 6, further comprising, near each of the opposing ends, a first pair of flanges in laterally opposing positions and formed at an angle relative to the strap unit.

10. The apparatus of claim 6, further comprising, adjacent to each of the fastener access holes, a second pair of flanges in laterally opposing positions and formed at an angle relative to the strap unit.

11. A method of anchoring a conduit to a support surface, the method comprising the steps of:
l) extending a strap unit around a first side of the conduit to establish a first partial wrap terminating at an access hole in the strap unit;
m) extending the strap unit around the first side of the conduit to establish a second partial wrap, the second partial wrap positioned between the first partial wrap and the conduit; and continuing to extend the strap unit around a second side of the conduit to establish a third partial wrap terminating at a second access hole in the strap unit positioned in opposition to the first access hole;
n) extending the strap unit around the second side of the conduit to establish a forth partial wrap overlaying the third partial wrap;
o) fastening the first and second partial wraps to the second and third partial wraps; and
p) fastening tab ends of the strap unit to a support surface thereby anchoring the strap unit and the conduit to the support surface.
